(19) United States
(12) Patent Application Publication
(10) Pub. No.: US 2006/0051157 A1
(43) Pub. Date: Mar. 9, 2006

(54) Systems, methods, and media for backing up a computer system

(75) Inventors: William Bornstein, Stormville, NY (US); Timothy Alan Dietz, Austin, TX (US); Anthony Cappa Spielberg, Austin, TX (US)

Correspondence Address: IBM CORPORATION (JSS);C/O SCHUBERT OSTERRIEDER & NICKELSON PLLC, 6013 CANNON MOUNTAIN DRIVE, S14, AUSTIN, TX, 78749, US

(73) Assignee: International Business Machines Corporation, Armonk, NY (US)

(21) Appl. No.: 10/937,691

(22) Filed: Sep. 9, 2004

(51) Int. Cl. B43K 5/00

(52) U.S. Cl. 401/206; 401/205

(57) ABSTRACT

Systems, methods and media for backing up a hard disk drive of a computer system are disclosed. Embodiments include capturing a series of commands to modify data on the hard disk drive, executing a data modification based on the series of commands, and storing an indication of the data modifications to one or more data storage devices. The data storage device may be used to help restore the hard disk drive in the event of loss of data from the primary hard disk drive. In one embodiment, the computer system may be a portable computer system and the data storage device may be a solid state storage device. In another embodiment, a second data storage device may be an external hard drive that mirrors the primary hard drive and is replicated at a remote location.

### FIELD OF INVENTION

The present invention is in the field of data processing systems and, in particular, to systems, methods and media for backing up a computer system. More specifically, the present invention relates to systems, methods, and media to back up modifications to the hard disk drive of a computer system.

### BACKGROUND

Personal computer systems are well known in the art. They have attained widespread use for providing computer power to many segments of today's modern society. Personal computers (PCs) may be defined as a desktop, floor standing, or portable microcomputer that includes a system unit having a central processing unit (CPU) and associated volatile and non-volatile memory, including random access memory (RAM) and basic input/output system read only memory (BIOS ROM), a system monitor, a keyboard, one or more flexible diskette drives, a CD-ROM drive, a fixed disk storage drive (also known as a “hard drive” or “hard disk drive”), a pointing device such as a mouse, and an optional network interface adapter. One of the distinguishing characteristics of these systems is the use of a motherboard or system planar to electrically connect these components together. Examples of such personal computer systems are International Business Machine Corporation's (IBM's®) PC 300, ThinkCentre, ThinkPad, Aptiva, and IntelliStation series of personal computers.

The use of mobile or portable computing devices, such as notebook or laptop computers, personal digital assistants (PDAs), sophisticated wireless phones, etc., has also become widespread. Portable computing devices typically exchange some functionality or performance when compared to traditional PCs in exchange for smaller size, portable power, and mobility.

The widespread use of PCs and mobile computing devices in various segments of society has resulted in a reliance on computer systems both at work and at home, such as for telecommuting, news, stock market information and trading, banking, shopping, shipping, communication in the form of hypertext transfer protocol (http) and e-mail, as well as other services. Because of the increased reliance on computers, avoiding the loss of computer data from a computer system has become increasingly important, particularly in corporate environments and enterprise computing. A hard disk drive, where data on a computer system is typically stored, is a device comprised of a platter of magnetic media and an electro-mechanical device (read-write head) to read data from and write data to the magnetic media. Data stored on the hard disk drive is vulnerable to a variety of failure modes, including the read-write head crashing into the magnetic media during physical jostling, software corruption, or virus attack.

The vulnerability of hard disk drive data is exacerbated for portable computers, which are often taken out of a stable and static environment and are instead used in a variety of locations to perform a wide array of tasks. As a result, environmental stresses such as temperature, humidity, vibration, and shock from being dropped or struck by an obstacle are more likely to cause data loss or hardware failure. Portable computers also have a higher overall and component failure rate than desktop computers.

One solution-to the problem of lost data is to allow the user to take snapshots of critical files and gives the user the responsibility to back up files. A backup system may restore data in these situations provided that a user has taken the time to frequently backup the data. Unfortunately, users typically postpone backups indefinitely because backing up data tends to be inconvenient and time-consuming.

Software solutions exist that provide real-time buffering of hard disk drive activity to a protected cache area on the hard disk drive. Two of such software solutions are backup solutions known as Symantec Corporation's GoBack™ and IBM's® Rapid Restore™. Each of these solutions removes the responsibility from the user and operates transparent to the user. GoBack™ captures every transaction that affects the contents of the hard drive and writes the consequences of the transaction to a designated protected partition of that hard drive. In the case of a system crash, the contents of the hard drive may be restored to a previous healthy state by accessing saved changes from the protected partition. Rapid Restore™ protects against unexpected hard drive disasters by creating a bootable partition that contains a backup of critical files. Both solutions provide some protection against user error, corruption of an operating system, loading defective software, or virus attacks. Neither solution, however, provides protection against hardware failure of the hard disk drive itself.

An alternate solution is software and hardware to continuously back up data to an extra hard disk drive using mirroring software. But, for a portable computer, an extra hard disk drive is physically large, consumes power, and is subject to the same failure mechanisms as the original hard disk drive. For example, two hard disk drives in a portable computer that mirror each other would provide a good level of protection against a manufacturing defect rendering one disk inoperable, as the same defect crippling the second disk is unlikely. If the user drops the portable computer; however, both hard disk drives might be destroyed simultaneously.

There is, therefore, a need for an effective system to backup the hard disk drive of a computer system in the event of software and/or hardware failures. There is an even greater need for such a system when portable computers are used, as the risk of hard disk drive failure is higher and many existing solutions are less effective.

### SUMMARY OF THE INVENTION

The problems identified above are in large part addressed by systems, methods and media for backing up a computer system. One embodiment provides a backup system for a computer system having a primary hard disk drive. The system may generally include a portable data storage device, a capture module for capturing any commands to modify data on the primary hard disk drive, and a cache writing module for storing an indication of any commands to modify the data captured by the capture module to a cache. The system also generally includes a mirroring module adapted to mirror the primary hard disk drive on to the external data storage device and a network backup module adapted to replicate the mirrored copy of the primary hard disk drive stored on the external data storage device to a remote storage location via a network. In some embodiments, the portable data storage device may be a solid state storage device, where the device is adapted to serve as the cache. A further embodiment includes a restore module for restoring the primary hard disk drive based at least in part on the indication of the commands to modify the data stored in the cache or on the replicated mirrored copy of the primary hard disk drive stored at the remote location.

Another embodiment provides a method for backing up a computer system that generally provides for capturing a series of commands to modify data on a primary hard disk drive and executing the data modifications based on the series of commands. The method also generally includes storing indications of the data modifications to a data storage device which is a separate device from the primary hard disk drive, where the indications of the data modifications are adapted to be used to restore the data on the primary hard disk drive. The method may further include resetting the data storage device or restoring the data on the primary hard disk drive based on the indications of the data modifications saved on the data storage device. The data storage device may be a solid state storage device, an external hard disk drive, etc.

Another embodiment provides a machine-accessible medium containing instructions effective, when executing in a data processing system, to cause the system to perform a series of operations for backing up a computer system. The series of operations generally includes capturing a series of commands to modify data on a primary hard disk drive and executing the data modifications based on the series of commands. The series of operations also generally includes storing indications of the data modifications to a separate data storage device, where the indications of the data modifications are adapted to be used to restore the data on the primary hard disk drive. The series of operations may further include resetting the data storage device or restoring the data on the primary hard disk drive based on the indications of the data modifications saved on the data storage device.

### BRIEF DESCRIPTION OF THE DRAWINGS

Other objects and advantages of the invention will become apparent upon reading the following detailed description and upon reference to the accompanying drawings in which, like references may indicate similar elements:

FIG. 1 depicts an environment for a system for backing up a computer system according to one embodiment;

FIG. 2 depicts a front cut-away view of certain elements of a computer system according to one embodiment;

FIG. 3 depicts a block diagram of certain components of the computer system of FIG. 2;

FIG. 4 depicts a computer backup system according to one embodiment;

FIG. 5 depicts an example of a flow chart for backing up a computer system using a portable data storage device according to one embodiment; and

FIG. 6 depicts an example of a flow chart for backing up a computer system using an external data storage device according to one embodiment.

### DETAILED DESCRIPTION OF EMBODIMENTS

The following is a detailed description of example embodiments of the invention depicted in the accompanying drawings. The example embodiments arc in such detail as to clearly communicate the invention. However, the amount of detail offered is not intended to limit the anticipated variations of embodiments; on the contrary, the intention is to cover all modifications, equivalents, and alternatives falling within the spirit and scope of the present invention as defined by the appended claims. The descriptions below are designed to make such embodiments obvious to a person of ordinary skill in the art.

Generally speaking, systems, methods and media for backing up a hard disk drive of a computer system are disclosed. More particularly, hardware and/or software for backing up a computer system using an external or portable data storage device are disclosed. Embodiments include capturing a series of commands to modify data on the hard disk drive, executing a data modification based on the series of commands, and storing an indication of the data modifications to one or more data storage devices. The data storage device may be used to help restore the hard disk drive in the event of loss of data from the primary hard disk drive. In one embodiment, the computer system may be a portable computer system and the data storage device may be a solid state storage device. In another embodiment, a second data storage device may be an external hard drive that mirrors the primary hard drive and is replicated at a remote location.

The disclosed embodiments may help provide an additional layer of security for users of computer systems with hard disk drives. In one embodiment, a user with a computer system may use a portable data storage device, such as a solid state storage device, to replicate modifications to the hard disk drive of the portable computer system while the user is away from the network, their office, etc. In the event of a hard disk drive failure, the contents of the portable data storage device may be used to restore the contents of the hard disk drive. Because the portable data storage device is separate from the hard disk drive, it may survive the conditions that caused the hard disk drive to fail. This is particularly true when a solid state storage device is used, as solid state storage devices are typically far more durable than hard disk drives. This embodiment may be particularly useful with portable computer systems such as notebook computers that are used away from a network or office environment.

The disclosed embodiments may also help provide an additional layer of security for users of computer systems with external data storage devices. In one embodiment, a user with a computer system may have an external data storage device, such as an external hard drive, mirroring their hard disk drive. The external data storage device may then be replicated at a remote location via a network. This provides for additional security for a user in the event that their hard disk drive and the mirrored external data storage device both fail simultaneously, such as in the event of a fire, electrical shock, etc. If the data from both is lost, data may be recovered from the remote location.

A backup system for a hard disk drive of a computer system that utilizes both a portable data storage device and an external data storage device may be particularly advantageous. In this embodiment, the data on the hard disk drive is protected both when the computer system is on the network (via the external data storage device that is replicated at a remote location) and while it is off the network (via the portable data storage device). This provides a seamless and continuous backup system for a user of a portable computer system that minimizes actions required by the user and provides enhanced backup of data.

While specific embodiments will be described below with reference to particular configurations of hardware and/or software, those of skill in the art will realize that embodiments of the present invention may advantageously be implemented with other substantially equivalent hardware and/or software systems.

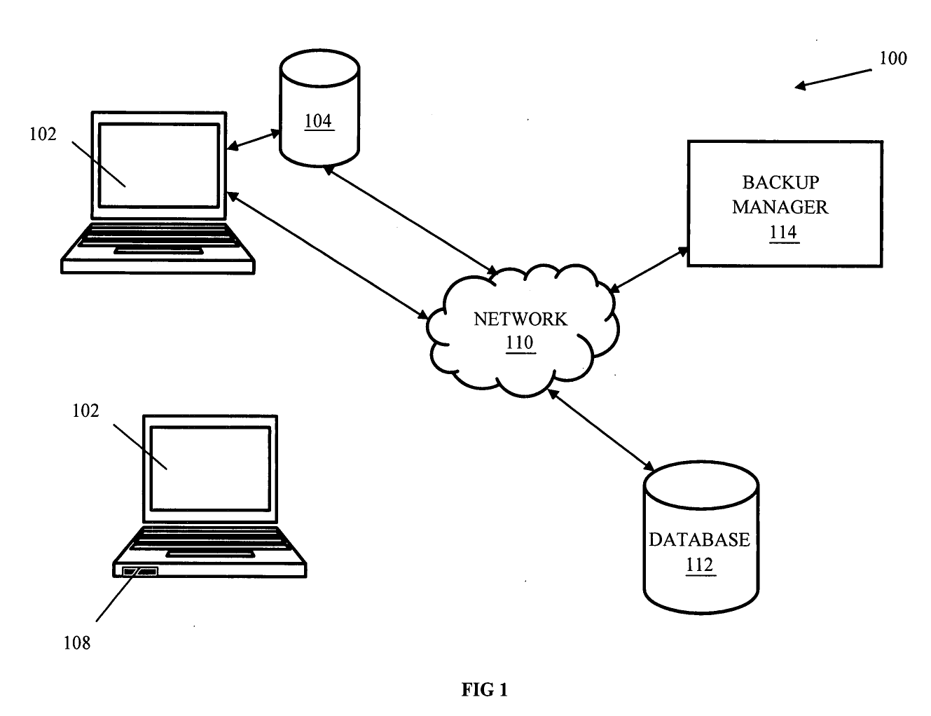

Turning now to the drawings, FIG. 1 depicts an environment for a system for backing up a computer system according to one embodiment. In the depicted embodiment, computer backup system 100 includes one or more computer systems 102 in communication with a network 110 and an external data storage device 104. Computer backup system 100 may also include one or more computer systems 102 being utilized away from network 110. A computer system 102 being used away from network 110 may include a portable data storage device 108 such as a solid state memory device or drive for use away from network 110. In one embodiment, computer system 102 is a portable computer system that may be used both in communication with and away from network 110 at different times, such as a notebook computer used in communication with network 110 part of the time (e.g., while at the office) and away from network 110 at other times (e.g., out in the field, at home, etc.).

Computer backup system 100 may also include a backup manager 114 in communication with network 110 for managing the computer backup system 100 and database 112 in communication with the backup manager 114, the network 110, etc. In computer backup system 100, the computer systems 102, external data storage device 104, backup manager 114, and database 112 may be located at the same location, such as in the same building or computer lab, or could be remote. While the term “remote” is used with reference to the distance between the components of backup computer system 100, the term is used in the sense of indicating separation of some sort, rather than in the sense of indicating a large physical distance between the systems. For example, any of the components of backup computer system 100 may be physically adjacent or located as part of the same computer system in some network arrangements.

Network 110 may be any type of data communications channel, such as the Internet, an intranet, a LAN, a WAN, an Ethernet network, a wireless network, a proprietary network, a broadband cable network, etc. Those skilled in the art will recognize, however, that the invention described herein may be implemented utilizing any type of data communications channel.

Computer systems 102 may include personal computers, workstations, servers, mainframe computers, notebook or laptop computers, tablet PCs, desktop computers, portable computer system, PDAs, set-top boxes, mobile phones, wireless devices, or the like. Portable computer systems 102, such as those adapted to be transported by a user, vehicle, etc. or are otherwise mobile, are particularly suited for use as computer systems 102. External data storage device 104 may be any device adapted to store data for a computer system 102, such as an external hard drive, external floppy drive, Hitachi Global Storage Technologies Microdrive, etc., and be in communication with a computer system 102, such as by cable, network cable, USB cable, FireWire cable, docking station, wireless connection, etc.

In one embodiment, a computer system 102 may include a portable data storage device 108. A computer system 102 that is portable or mobile and is expected to be out of communication with the network 110 at some time is particularly suited for use with a portable data storage device 108. Portable data storage devices 108 may include solid state storage devices, such as flash memory cards, flash drives, USB flash drives, smart card, CompactFlash® (CF) cards, solid-state floppy-disk card (SSFDC, or SmartMedia™ cards) cards, Sony Corporation's Memory Stick, Personal Computer Memory Card International Association (PCMCIA) standard memory cards, etc. Solid state devices are semiconductor devices that control electrons, electronic fields and magnetic fields in a solid material and typically have no moving parts. Solid state storage devices are non-volatile and typically can withstand much more physical shock than hard disk drive storage systems. Solid state storage devices are generally more expensive per unit of storage than hard disk storage devices. Solid state storage devices which are smaller in storage capacity than the hard disk drive may suitably be used in the disclosed embodiments, however, as the portable data storage device 108 need only store modifications to the hard disk drive, not the entire contents, which allows for smaller (and less expensive) capacities. Portable data storage devices 108 may be in communication with the portable computer system via a wireless link (e.g., Bluetooth, etc.) or through a USB link, FireWire link, PCMCIA card slot, floppy drive port, etc., or by any other means. Portable data storage device 108 may also be a microdrive, CD-RW, DVD-RW, etc.

In one embodiment, the portable data storage device 108 may be a device that fits into a slot in the computer system 102, such as PCMCIA slot or USB port. In other embodiments, the portable data storage device 108 may be located internally to the computer system 102, located nearby and connected via a wireless link, etc.

Optional backup manager 114 may be executing on one or more personal computers, workstations, servers, mainframe computers, notebook or laptop computers, desktop computers, PDAs, set-top boxes, mobile phones, wireless device, or the like. In one embodiment, the backup system manager 114 may be a server in communication with a plurality of computer systems 102 via network 110. Backup manager 114 may facilitate the backup of the computer systems 102, replication of external data storage devices 104 to a remote database such as database 112, permissions for users, restoration of lost data on the computer systems 102, etc.

Optional database 112 may provide storage for any type of information for the backup manager 114, such as information about user preferences, current state of backup systems, etc. Database 112 may also include copies of hard disk drives of computer systems 102, replicated mirrored external data storage devices 104, etc. Database 112 may be located anywhere within computer backup system 100, including as a standalone database, as part of the backup manager 114, on a server farm, on a server, etc., and may be stored on any type of storage device, such as hard disk drives, volatile or non-volatile memory, etc.

In one embodiment, the computer backup system 100 may be used to provide backup capability for a computer system 102 being used away from the network 110. This embodiment may be useful when a computer system 102 is being used out in the field, remotely, or disconnected from a network, such as by users working from home, on business travel, on calls in the field, etc. Disconnected from a network or external storage devices, the computer system 102 could be subject to loss of hard disk drive data in the event of a software and/or hardware malfunction. Disclosed embodiments provide a portable data storage device 108, such as a solid state storage device, to which any changes to the hard disk drive may be saved. In these embodiments, a copy of the hard disk drive may be saved before the computer system 102 is being used remotely, such as by making a copy of the hard disk drive on database 112 via network 110 or on external data storage device 104 before leaving on a trip, going home, etc. In the event that the hard disk drive of the computer system 102 fails, the last state of the hard disk drive may then be recreated using the saved copy of the hard disk drive before the computer system 102 left the network connection and the saved modifications in the portable data storage device 108. These embodiments provide an improved backup capability by storing modifications to the hard disk drive on a separate portable data storage device 108. A solid state portable data storage device 108, for example, is much more durable than a hard disk drive, so an impact that damages the hard disk drive may not hurt the solid state portable data storage device 108, offering the user a secure way of restoring the hard disk drive. Moreover, a software problem that damages data on the hard disk drive may not impact the data on the portable data storage device 108, providing additional security.

In another embodiment, the computer backup system 100 may be used to provide improved backup capability for a computer system 102 connected to a network 110. In this embodiment, an external data storage device 104, such as an external hard disk drive, may be used to mirror the hard disk drive of computer system 102. While mirroring of a hard disk drive with another hard disk drive is well known in the art, the system is still subject to certain failures that may destroy data on both hard disk drives. For example, a fire in the office containing both computer system 102 and external storage device 104 or a power surge could result in the loss of all data, and a software bug or virus could similarly destroy data on both devices. Computer backup system 100 provides for replication of the contents of the external data storage device 104 (i.e., the mirrored hard disk drive) to a remote location, such as a database 112 accessed via network 110. In this embodiment, the contents of the external data storage device 104 could be replicated on a periodic basis, continually as data is modified, at specified time intervals, per user request, per administrative setting using backup manager 114, etc. This provides additional protection for a user in the event of simultaneous failure of the hard disk drive of the computer system 102 and the external data storage device 104. By replicating the external data storage device 104 periodically instead of just mirroring the hard disk drive over the network 110, network loads may be managed and minimized.

The computer backup system 100 may be used to provide seamless and continuous backup capability for the user of a computer system 102 that operates both on and off the network 110 by combining the previous two embodiments. While a computer system 102 is on the network 102, the contents of the hard disk drive may be mirrored to an external data storage device 104 and when the computer system 102 is taken off of the network 110, any changes to the hard disk drive may be saved to a portable data storage device 108. In the event of loss of data on the hard disk drive, the data may be recovered from the portable data storage device 104, external data storage device 104, database 112, and/or any other location as is appropriate.

The computer backup system 100 of the disclosed embodiments is substantially transparent to users, as it operates in the background until a failure of a hard drive actually occurs. This makes the backup system more likely to be used and to be effective as it does not rely on the actions of potentially unreliable end-users. The computer backup system 100 of the disclosed embodiments is also easy to implement on an enterprise-scale, as the modules may run in the background and network traffic may be customized so as to minimize impact on the network.

Computer backup system 100 as disclosed is a hierarchical system, as data may be moved from different levels of storage as needed. For example, data from the hard drive of computer system 102 may be moved as desired to a nearby external data storage device 104, data may then be moved as desired from the external data storage device 104 over the network 110 to a database 112, etc. This allows network traffic to be optimized by scheduling the various communications. In one example, the transmission of data over the network 110 may be scheduled so that all systems are not transmitting at the same time, so that transmissions occur when network traffic is at its lowest, etc. This provides an advantage over, say, continuously transmitting changes over the network 110, as changes are most likely to occur during periods of heavy network traffic (i.e., when most users are active during the normal workday). This hierarchical arrangement minimizes the intrusion of computer backup system 100 on users and/or the network 110.

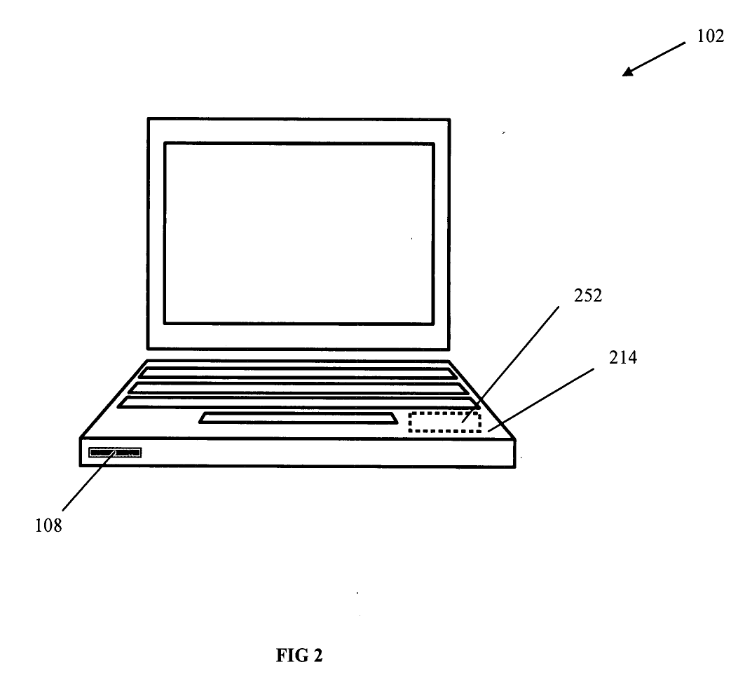

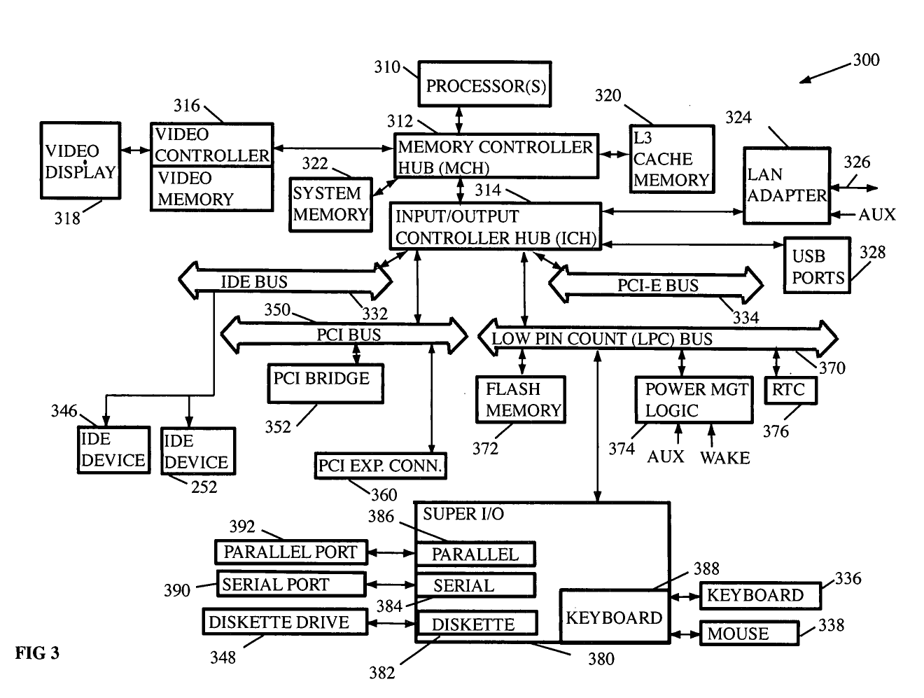

FIGS. 2 and 3 depict one embodiment of a computer system 102 suitable for use as, for example, a portable computer system 102 such as a notebook computer. Other possibilities for the computer system 102, including a computer having capabilities other than those ascribed herein to a “personal computer”, and possibly beyond those capabilities, and they may, in other embodiments, be any combination of processing devices such as workstations, servers, mainframe computers, notebook or laptop computers, tablet PCs, desktop computers, PDAs, mobile phones, wireless devices, set-top boxes, or the like.

FIG. 2 depicts a front cut-away view of certain elements of a computer system 102 according to one embodiment. Cover 214 is a decorative outer member that cooperates with a chassis (not shown) in defining an enclosed, shielded interior volume for receiving electrically powered data processing and storage components to process and store digital data. At least certain of these components may be mounted on a multi-layer planar or motherboard which may be mounted on the chassis and may provide a means for electrically interconnecting the components of the computer system 102, including those identified above and such other associated elements as floppy disk drives, various forms of direct access storage devices, accessory adapter cards or boards, and the like. Computer system 102 may have a power supply that may be actuated by a power switch (not shown). Computer system 102 includes a hard disk drive 252, which is a fixed medium DASD capable of storing and delivering data as is generally known.

Referring now to FIG. 3, there is shown a block diagram 300 of certain components of the computer system 102 of FIG. 2. The components of FIG. 3 comprise components mounted on the planar or other hardware of the computer system 102. Connected to the planar is the system CPUs or processor(s) 310, which may be connected directly to a memory controller hub (MCH) 312. As one example, the system processor(s) 310 could be an Intel® Pentium® processor, Advanced Micro Devices' Athlon™ processor or any other suitable processor.

MCH 312 and input-output (I/O) controller hub (ICH) 314 represent part of the personal computer's 212 core logic chipset, facilitating access to/from processor(s) 310 from/to memory devices and I/O devices, respectively. More specifically, MCH 312 may provide access to system memory 322 and level three (L3) cache memory 320. In many such embodiments, level one (L1) and level two (L2) cache are incorporated into each processor of processor(s) 310. MCH 312 may also include a special bus adapted for direct memory access (DMA) by a video controller. In other embodiments, a peripheral component interconnect (PCI) bus such as a PCI-E bus may be implemented for video display 318. System memory 322 may include random access memory (RAM) such as double data rate (DDR) synchronous dynamic random access memory (SDRAM).

Input/Output Controller Hub (ICH) 314 may be designed to coordinate communications with various I/O devices. In the depicted embodiment, ICH 314 couples with local area network (LAN) adapter 324, universal serial bus (USB) ports 328, integrated drive electronics (IDE) bus 332, PCI Express (PCI-E) bus 334, PCI bus 350, and low pin count (LPC) bus 370. LAN adapter 324 may be coupled to either the PCI bus 350 or directly to ICH 314 to facilitate communication (i.e., transmit/receive data) with a remote computer or server over a LAN via a connection or link 326. LAN adapter 324 may be a card to be plugged in portable computer system 106 or a LAN connection embedded on the planar 232. LAN adapter 324 may also be known as a network interface card (NIC).

IDE bus 332 and PCI-E bus 334 may be incorporated to facilitate connection of additional I/O devices with ICH 314. IDE bus 332 is a type of hardware interface widely used to connect hard disk drives, CD-ROMs and tape drives to a PC. IDE bus 332 provides for the attachment for devices such as hard disk drive 252 and CD-ROM drive 346. PCI-E bus 334 may be a high-speed peripheral interconnect. PCI bus 350 may couple a PCI bridge 352 to facilitate the connection of additional PCI devices and a PCI expansion connector 360 to facilitate expansion of the PCI bus 350 so even more peripheral devices can communicate with ICH 314 via PCI bus compatible peripheral cards.

In one embodiment, the modifications to the data of the hard disk drive 252 may be captured at the ICH hub 314. In one embodiment, a software agent could monitor the buffer or cache for the hard drive controller (IDE bus 332) to identify and copy writes to (and deletes from) the hard drive as they are received. This embodiment may be particularly advantageous as it has only minimal impact on performance. In another embodiment, a software agent in the ICH hub 314 may monitor the transactions from the main bus to the IDE bus 332. In another embodiment, a software agent on the main bus may monitor that bus for transactions destined for the IDE bus 332.

Portable computer system 106 may include one or more USB ports 328, which are hardware interfaces for peripherals such as the keyboard, mouse, joystick, scanner, printer, telephony devices, hard drives, compact disk (CD) drives, DVD drives, and the like. In one embodiment, a portable data storage device 108 may be connected to computer system 102 (such as a portable computer system 106) via one of the USB ports 328.

Attached to the LPC 370 may be a flash memory (FM) module or chip 372, power management logic 374, and a real-time clock (RTC) 376, and a multi-function or super I/O controller 380. Flash memory module 372 contains microcode that portable computer system 106 may execute on power on and may be a non-volatile memory module or chip. Power management logic 374 allows for changing between various power states (e.g., off, suspend and normal operating states). The RTC 376 may be used for time of day calculations. Super I/O controller 380 may include functionality such as, for example, a National Semiconductor PC87307. The super I/O controller 380 may contain a variety of I/O adapters and other components such as the diskette adapter 382, serial adapter 384, a parallel adapter 386 and keyboard controller 388. The diskette adapter 382 provides the interface to the diskette drive 348. The serial adapter 384 has an external port connector, serial port 390, for attachment of external devices such as modems (not shown). The parallel adapter 386 has an external port connector, parallel port 392, for attachment of external devices such as printers (not shown). The keyboard controller 388 is the interface for the connectors, keyboard 336 and mouse 338.

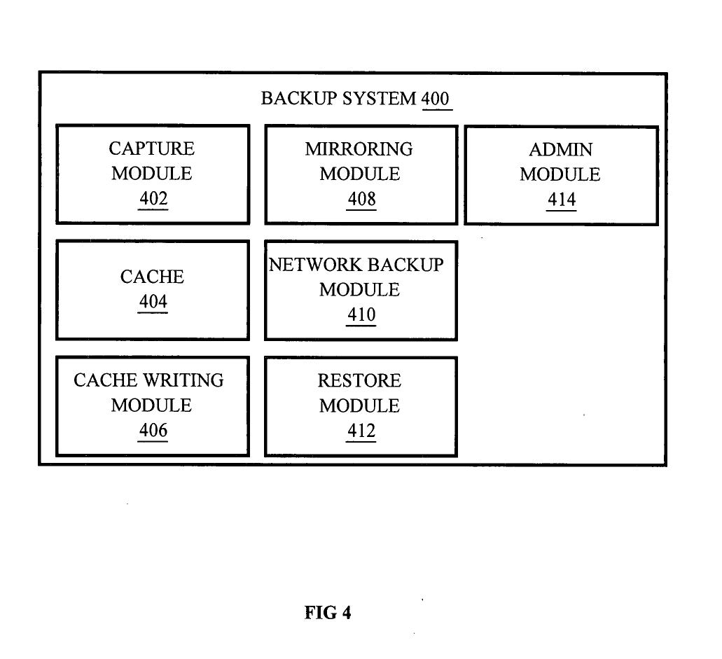

FIG. 4 depicts one embodiment of a backup system 400 according to one embodiment. In the depicted embodiment, the backup system 400 includes a capture module 402, a cache 404, a cache writing module 406, a mirroring module 408, a network backup module 410, a restore module 412, and an administration module. Some or all of the components of the backup system 400 may be located on a computer system 102 and/or the backup manager 114.

In one embodiment, the capture module 402 may be used to capture any modifications (or requested modifications) to the hard disk drive 252 of computer system 102. Modifications to the primary hard disk drive 252 may include any new files, deleted files, or changed files. The primary hard disk drive 252 may be any hard disk drive for which data is being backed up. Modifications may result from user actions, such as modifying and saving a version of a document saved on the primary hard disk drive 252. Modifications may also occur from other sources, such as a virus that modifies or deletes drivers or other files off of the primary hard disk drive 252. Enough information may be captured so that any change may be reversed and the primary hard disk drive 252 reinstated to its earlier condition. For example, if a file is deleted, the original file should be saved. Likewise, if a file is modified, both the new and original version may be captured. Modifications to the data of hard disk drive 252 may be captured at the ICH hub 314, the IDE bus 332, at the hard disk drive 252, etc.

Backup system 400 may also contain a cache 404 and a cache writing module 406. The cache 404 may be any storage device, such as a portable data storage device 108, an external data storage device 104, memory module, a second hard disk drive, etc. Cache writing module 406 may be used to write or save any modifications captured by the capture module 402 to the cache 404. Modifications may include any type of write transaction or other transaction that may modify any data on the hard disk drive 252. In one embodiment, every write transaction against the hard disk drive 252 may be written to the cache 404 by the cache writing module 406. In an alternative embodiment, write transactions that cancel each other out are not saved to the cache 404. In this embodiment, space in the cache 404 may be saved by eliminating information that adds no value, such as when a file is added and then deleted. In another embodiment, data may be stored in a buffer before writing to the cache 404.

Mirroring module 408 may mirror primary hard disk drive 252 on another hard disk drive, such as an external hard disk drive serving as the external data storage device 104. Mirroring a hard disk drive entails making a copy of a primary hard disk drive 252 and continually updating the mirror hard disk drive as the primary hard disk drive is modified. In one embodiment, the mirroring module 408 performs many of the functions of the capture module 402 and the cache writing module 406 combined, except that the mirroring module 408 typically operates on the entire contents of the hard disk drive, not just the changes to the hard disk drive.

Network backup module 410 may be used to backup the contents of a hard disk drive, such as the primary hard disk drive or an external hard disk drive, over network 110. The hard disk drive may be backed up to a remote database such as database 112 or other location. Backup of the hard disk drive 252 of a computer system 102 provides a baseline hard disk drive state so that modifications to that state may be saved in the cache 404, allowing the backup of the primary hard disk drive 252 and the cache 404 to be combined to recreate the state of the primary hard disk drive 252 at failure. Similarly, backup of the mirrored hard disk drive serving as the external data storage device 104 to a database 112 provides additional security in the event that both primary hard disk drive 252 and the external data storage device 104 fail.

The restore module 412 may restore the contents of a hard disk drive such as primary hard disk drive 252 or the external data storage device 106. In one embodiment, the restore module 412 may access the saved copy of primary hard disk drive 252 from remote storage, such as database 112, as well as the contents of the cache 404, which contains an indication of modifications to the primary hard disk drive 252 since the last time the primary hard disk drive 252 was saved, in order to restore the contents of a failed primary hard disk drive 252. The restore module may, in this embodiment, start with the last saved version of the primary hard disk drive 252 and “play” the modifications recorded in the cache 404 to reach the last point before the primary hard disk drive 252 failed. The restore module 412 may also restore the primary hard disk drive 252 to any interim point based on the content of the cache 404, not just the point before failure. This embodiment may be particularly useful for a portable computer system 102 with a portable data storage device 108 serving as the cache 404. In this example, the user with a portable computer system 102 may save a copy of their primary hard disk drive 252 before leaving the network 110 (i.e., their office) and use the portable data storage device 108 to record any modifications to their hard disk drive 252 while they are out. If their hard disk drive 252 fails during their time away, a user may use the restore module 412 to combine the saved copy of the hard disk drive 252 and the recorded modifications on the portable data storage device 108 to recreate the state of the hard disk drive 252 before it failed, providing a reliable backup for their hard disk drive 252.

In an alternative embodiment, the restore module 412 may simply access the replicated copy of the primary hard disk drive 252 (or the mirrored version) over network 110 in the event that a hard disk drive 252 and the external data storage device 106 both fail. In an embodiment where the remote storage (such as database 112) is being continually updated, an excellent restoration is possible. In an embodiment where the remote storage is being periodically updated, a restoration based on the last saved copy of primary hard disk drive 252 and/or the mirrored copy of the external data storage device 104 is possible. In an alternative embodiment, both an external data storage device 104 and a portable data storage device 108 are included, allowing the restore module 412 to use the saved network copy and the modifications saved on the portable data storage device 108 to recreate a state of the primary hard disk drive 252.

Backup system 400 may also include an administration module 414, which may control and configure various settings of system 100. In one embodiment, the administration module 414 executes on the backup manager 114, but it may also execute in whole or in part on a computer system 102 or other device. The administration module 414 may add or delete users, modify user permissions, set backup frequencies, configure database 112, redirect resources via network 110, etc.

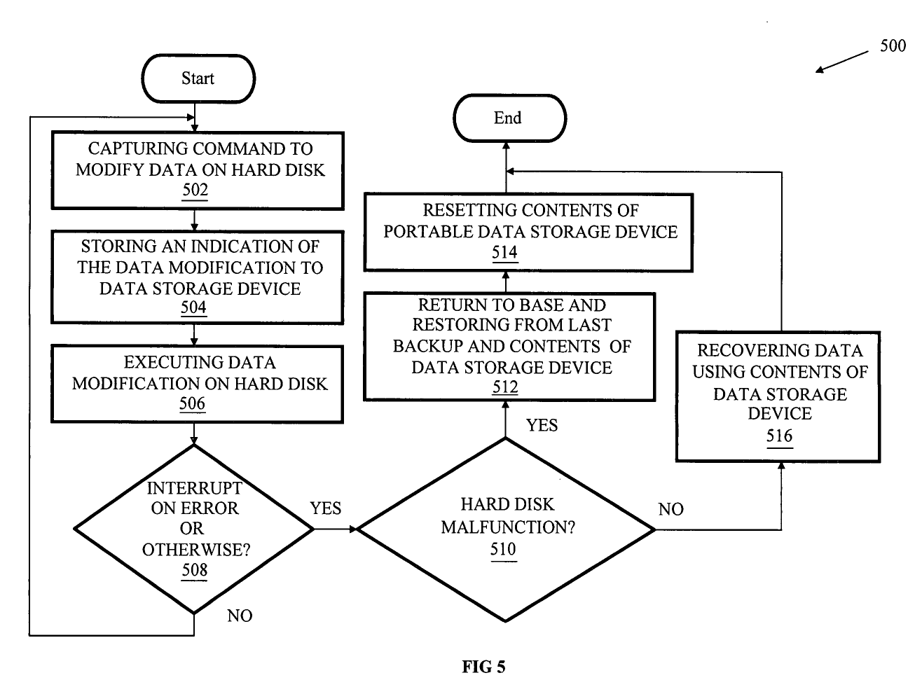

FIG. 5 depicts an example of a flow chart 500 for backing up a computer system 102 using a portable data storage device 108 according to one embodiment. The function of flow chart 500 may be performed on a computer system 102 or any other system or combination of systems. Flow chart 500 begins with element 502, capturing a command to modify data on a primary hard disk drive 252. Modifications to the primary hard disk drive 252 include adding new files, deleting files, or changing files, or any other modifications. Enough information may be captured so that any change may be reversed and the primary hard disk drive 252 reinstated to its earlier condition (or any earlier condition). For example, if a file is deleted, the original file should be saved. Likewise, if a file is modified, both the new and original version may be captured. If a file is modified a number of times, each modification may be saved.

Flow chart 500 continues to element 504, storing an indication of the data modification to the data storage device. In element 504, the method may store indications of the data modifications captured in element 502 in the cache 404, on a portable data storage device 108, on an external data storage device 104, or any other location. Elements 502 and 504 may be performed by the capture module 402 and cache writing module 406, the mirroring module 408, etc. Flow chart 500 then continues to element 506, executing the data modification on primary hard disk drive 252. In this element, the requested modification to the primary hard disk drive 252 (e.g., added file, deleted file, modified file, etc.) captured in element 502 is executed on the hard disk drive 252. The functions of elements 504 and 506 may be conducted in any order; for example, the indication of the data medication may be stored on the data storage device before the primary hard disk drive 252, the modification may be executed on the primary hard disk drive 252 before storing an indication of it on the data storage device, the two operations may be conducted in parallel, etc.

In decision block 508, the method of flow chart 500 determines if there is an error or other interruption in primary hard disk drive 252 that resulted in the loss of some data. Errors may include hardware or software failures or other problems that cause the loss or modification of data on primary hard disk drive 252, such as physical crashes, damaging software viruses, etc. Errors may also include user-requested changes to primary hard disk drive 252 data for which the user desires restoration, such as after the inadvertent deletion or modification of files. If there is no primary hard disk drive 252 error, the flow chart continues processing, such as by returning to element 502 to await the next command to modify data on the primary hard disk drive 252. If there is a primary hard disk drive 252 error or if the user requests to undo a modification to the primary hard disk drive 252, the flow chart continues to decision block 510.

In optional decision block 510, the method determines if the primary hard disk drive 252 malfunctioned or failed. If the primary hard disk drive 252 did not malfunction or fail and is still operational, the method continues to element 516, recovering data using contents of data storage device, after which flow chart 500 terminates. In this situation, a user on a computer system 102, for example, could reverse modifications made to the primary hard disk drive 252 by accessing the transactions from the portable data storage device 108 on which they are stored. This embodiment may be particularly useful when a user wants to “erase” some of the actions they took, such as mistakenly deleting a file, or if the effects of a virus that changed or deleted files are to be eliminated by restoring the files.

If the primary hard disk drive 252 did fail or malfunction, the method continues to element 512, restoring the data from the last backup and the contents of the data storage device. If a user is using a portable or mobile computer system 102, this would require returning to the networked environment (i.e., the office, etc.) to access the network 110 and other resources. In one example, a user with a portable computer system 102 using a portable data storage device 108 to record primary hard disk drive 252 transactions could suffer a primary hard disk drive 252 failure out in the field. Upon return to the office, they could receive a new primary hard disk drive 252 on which may be copied the last saved backup version on the network 110 (such as from database 112) and modifications captured on the portable data storage device 108. In this fashion, the state of the user's primary hard disk drive 252 at the time of failure may be easily recreated, eliminating the loss of data. After the data is recovered, the method continues to optional element 514, resetting the contents of the portable data storage device 108, after which flow chart 500 terminates. Resetting the data storage device allows the portable data storage device 108 to have the maximum capacity for storing modifications for future use.

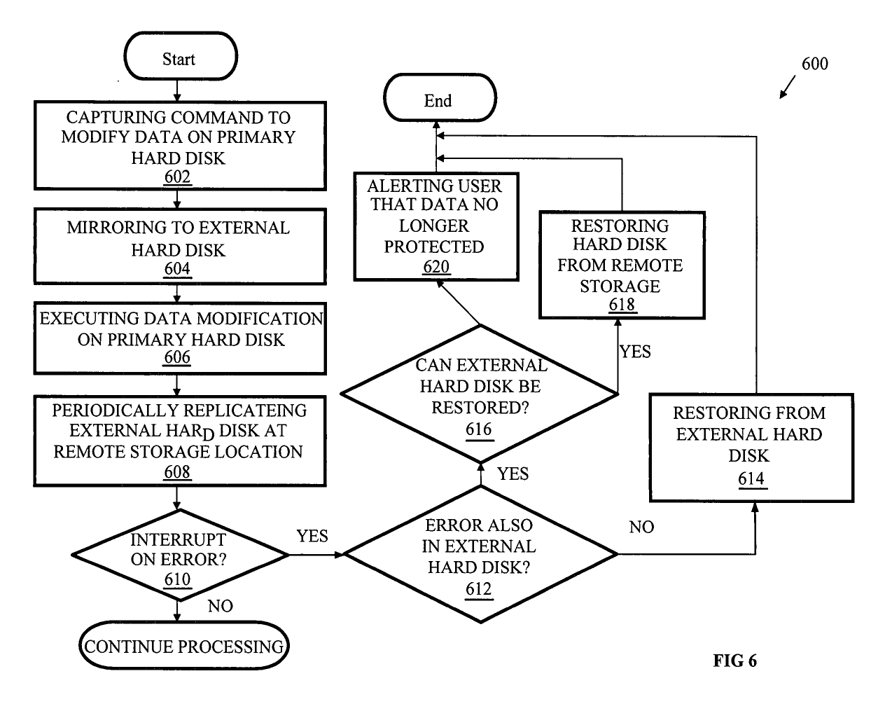

FIG. 6 depicts an example of a flow chart for backing up a computer system 102 using an external data storage device 104 according to one embodiment. The function of flow chart 600 may be performed on a computer system 102 or any other system or combination of systems. Flow chart 600 begins with element 602, capturing a command to modify data on a primary hard disk drive 252. Modifications to the primary hard disk drive 252 include adding new files, deleting files, or changing files, or any other modifications. Enough information may be captured so that any change may be reversed and the primary hard disk drive 252 reinstated to its earlier condition (or any earlier condition). For example, if a file is deleted, the original file should be saved. Likewise, if a file is modified, both the new and original version may be captured. If a file is modified a number of times, each modification may be saved.

Flow chart 600 continues to element 604, mirroring the primary hard disk drive 252 to an external hard disk drive or other external data storage device 104. Mirroring entails recreating a primary hard disk drive 252 in full on a second hard disk drive. Mirroring differs from the function of flow chart 500 as element 504 only saves modifications to the primary hard disk drive 252 to the portable data storage device 108, not the entire contents of the disk. Flow chart 600 continues to element 606, executing the data modification on primary hard disk drive 252. The functions of elements 604 and 606 may be conducted in any order; for example, the mirroring may occur before the data modification is executed or vice versa, or the two operations may be conducted in parallel, etc.

Flow chart 600 then continues to element 608, replicating the external hard disk drive or other external data storage device 104 at a remote storage location. The external data storage device 104 may be replicated periodically (i.e., at set times, every hour, daily, etc.), after a certain amount of modifications have occurred, upon user or administrator request, continuously as modifications are made, etc. The content of the external data storage device 104 may be replicated to a remote database, such as database 112, via network 110. In an alternative embodiment, the content may be replicated to another storage medium, such as CD-ROM, DVD-ROM, tape drive, etc. a

In decision block 610, the method of flow chart 600 determines if there is an error or other interruption in primary hard disk drive 252 that resulted in the loss of some data. Errors may include hardware or software failures or other problems that cause the loss or modification of data on primary hard disk drive 252, such as physical crashes, damaging software viruses, etc. Errors may also include user-requested changes to primary hard disk drive 252 data for which the user desires restoration, such as after the inadvertent deletion or modification of files. If there is no primary hard disk drive 252 error, the flow chart continues processing, such as by returning to element 602 to await the next command to modify data on the primary hard disk drive 252. If there is a primary hard disk drive 252 error of if the user requests to undo changes to the primary hard disk drive 252, the flow chart continues to decision block 612.

In optional decision block 612, the method of flow chart 600 determines if the external data storage device 104 also malfunctioned or failed. If the external data storage device 104 did not malfunction or fail and is still operational, the method continues to element 614, restoring from the external data storage device 104, after which flow chart 600 terminates. In this situation, a user on a computer system 106, for example, could reverse modifications made to the primary hard disk drive 252 by accessing the transactions from mirrored external hard disk drive 104. This embodiment may be particularly useful when a user wants to “erase” some of the actions they took, such as mistakenly deleting a file, or if the effects of a virus that changed or deleted files are to be eliminated by restoring the files. In another example, if the primary hard disk drive 252 completely failed and was replaced, the replacement could be restored to the most recent state by copying the image from the mirrored external data storage device 104.

If the external data storage device 104 did also fail or malfunction, the method of flow chart 600 continues to decision block 616, determining if the external hard disk drive 104 can be restored. If the external data storage device 104 can be restored, the flow chart continues to element 618, where the external data storage device 104 is restored from the most recent copy in remote storage. Depending on the frequency of replication of the external data storage device 104, the data may not be the most recent state of the primary hard disk drive 252, but it still may be valuable. If the external data storage device 104 cannot be restored (i.e., it is also broken), the user may be alerted that their data is no longer protected.

The method of flow chart 600 provides an additional level of protection over systems where a computer system 102 with primary hard disk drive 252 has a mirrored external hard disk drive 104. In the embodiment of flow chart 600, a, user is protected for situations where both the primary hard disk drive 252 and external data storage device 104 fail by replication of the mirrored external data storage device 104 at a remote location. This may be particularly useful for situations where the primary hard disk drive 252 and external data storage device 104 are subject to the same physical threat, such as fire, electrical surge, flood, etc., or software threat, such as hackers, viruses, etc.

In general, the routines executed to implement the embodiments of the invention, may be part of an operating system or a specific application, component, program, module, object, or sequence of instructions. The computer program of the present invention typically is comprised of a multitude of instructions that will be translated by the native computer into a machine-readable format and hence executable instructions. Also, programs are comprised of variables and data structures that either reside locally to the program or are found in memory or on storage devices. In addition, various programs described hereinafter may be identified based upon the application for which they are implemented in a specific embodiment of the invention. However, it should be appreciated that any particular program nomenclature that follows is used merely for convenience, and thus the invention should not be limited to use solely in any specific application identified and/or implied by such nomenclature.

It will be apparent to those skilled in the art having the benefit of this disclosure that the present invention contemplates methods, systems, and media for backing up a computer system, particularly the hard disk drive of a computer system. It is understood that the form of the invention shown and described in the detailed description and the drawings are to be taken merely as examples. It is intended that the following claims be interpreted broadly to embrace all the variations of the example embodiments disclosed.

What is claimed is:

1. A backup system for a computer system having a primary hard disk drive, the system comprising:
a portable data storage device, the portable data storage device being adapted to serve as a cache;
a capture module, the capture module being adapted to capture any commands to modify data on the primary hard disk drive;
a cache writing module in communication with the capture module, the cache writing module being adapted to store indications of any commands to modify the data captured by the capture module to a cache on the portable data storage device;
a mirroring module in communication with the capture module, the mirroring module being adapted to mirror the primary hard disk drive on to the external data storage device; and
a network backup module, the network backup module being adapted to replicate the mirrored copy of the primary hard disk drive stored on the external data storage device to a remote storage location via a network.

2. The system of claim 1, wherein the portable data storage device is a solid state storage device.

3. The system of claim 1, further comprising a restore module, the restore module being adapted to restore the primary hard disk drive based at least in part on the indications of the commands to modify data stored on the portable data storage device.

4. The system of claim 1, further comprising a restore module, the restore module being adapted to restore the primary hard disk drive based at least in part on the replicated mirrored copy of the primary hard disk drive stored at the remote storage location.

5. The system of claim 1, further comprising a restore module, the restore module being adapted to restore the primary hard disk drive based at least in part on the indications of the commands to modify data stored on the portable data storage device.

6. The system of claim 1, wherein the computer system is a portable computer system.

7. The system of claim 1, wherein the computer system is a notebook computer.

8. The system of claim 1, wherein the external data storage device is an external hard drive.

9. The system of claim 1, wherein the network backup module replicates the mirrored copy to the remote storage location periodically.

10. The system of claim 1, wherein the network backup module replicates the mirrored copy to the remote storage location continuously.

11. The system of claim 1, wherein the network backup module replicates the mirrored copy to the remote storage location upon request.

12. A method for backing up a computer system, the method comprising:
capturing a series of commands to modify data on a primary hard disk drive;
executing the data modifications on the primary hard disk drive based on the series of commands; and
storing indications of the data modifications to a data storage device, wherein the data storage device is a separate device from the primary hard disk drive, and wherein further the indications of the data modifications are adapted to be used to restore the data on the primary hard disk drive.

13. The method of claim 12, further comprising:
wherein the data storage device is an external hard disk drive, and wherein further storing indications of the data modifications to the external hard disk drive includes mirroring the primary hard disk drive; and
replicating the external hard disk drive at a remote storage location via a network.

14. The method of claim 12, wherein the data storage device is a solid state storage device.

15. The method of claim 12, further comprising restoring the data on the primary hard disk drive based on the indications of the data modifications saved on the data storage device.

16. The method of claim 12, further comprising resetting the data storage device.

17. The method of claim 12, wherein the data modifications are executed on the primary hard disk drive before the indications of the data modifications are stored to the data storage device.

18. The method of claim 12, wherein the data modifications are executed on the primary hard disk drive in parallel with the indications of the data modifications being stored to the data storage device.

19. The method of claim 12, wherein the indications of the data modifications are stored to the data storage device before the data modifications are executed on the primary hard disk drive.

20. The method of claim 12, further comprising storing an image of the primary hard disk drive before the series of commands to modify data is captured.

21. The method of claim 12, further comprising receiving a request to undo at least one command to modify data.

22. A machine-accessible medium containing instructions effective, when executing in a data processing system, to cause said data processing system to perform operations comprising:
capturing a series of commands to modify data on a primary hard disk drive;
executing the data modifications on the primary hard disk drive based on the series of commands; and
storing a indications of the data modifications to a data storage device, wherein the data storage device is a separate device from the primary hard disk drive, and wherein further the indications of the data modifications are adapted to be used to restore the data on the primary hard disk drive.

23. The machine-accessible medium of claim 22, further comprising:
wherein the data storage device is an external hard disk drive, and wherein further storing indications of the data modifications to the external hard disk drive includes mirroring the primary hard disk drive; and
replicating the external hard disk drive at a remote storage location via a network.

24. The machine-accessible medium of claim 22, further comprising restoring the data on the primary hard disk drive based on the indications of the data modifications saved on the data storage device.

25. The machine-accessible medium of claim 22, further comprising resetting the data storage device.

26. The machine-accessible medium of claim 22, further comprising storing an image of the primary hard disk drive before the series of commands to modify data is captured.

27. The machine-accessible medium of claim 22, further comprising receiving a request to undo at least one command to modify data.
